(19) United States
(12) Patent Application Publication
(10) Pub. No.: US 2026/0225601 A1
(43) Pub. Date: Aug. 6, 2026

(54) ASSISTED DRIVING

(71) Applicant: QUALCOMM Incorporated, San Diego, CA (US)

(72) Inventors: Jan VEEN, Hallbergmoos (DE); Sibylle Tanja REBER, Gröbenzell (DE); Benjamin GAUDSZUN, Bibertal OT Schneckenhofen (DE); Joao Paulo JANSCH PORTO, Philadelphia, PA (US); Yavor Nikolaev TRASIEV, Mölndal (SE)

(21) Appl. No.: 19/043,300

(22) Filed: Jan. 31, 2025

(51) Int. Cl. B60W 50/08; B60W 50/14; B62D 15/02; G07C 5/02

(52) U.S. Cl. CPC B60W 50/085; B60W 50/14; B62D 15/021; B62D 15/029; G07C 5/02; B60W 2050/146; B60W 2540/18

(57) ABSTRACT

Systems and techniques are described herein for assisted driving. For instance, a method for assisted driving is provided. The method may include comparing a steering output signal to a measured steering signal, wherein the steering output signal is generated by a driving system of a vehicle and output to a steering system of the vehicle, and wherein the measured steering signal is based on a steering angle of a vehicle; and based on a difference between the measured steering signal and the steering output signal exceeding a threshold, generating a driver-is-interacting signal for indicating that a driver is interacting with one or more controls of the vehicle.

### TECHNICAL FIELD

The present disclosure generally relates to assisted driving. For example, aspects of the present disclosure include systems and techniques for assisted driving.

### BACKGROUND

Driving systems (e.g., autonomous, semi-autonomous, and/or assisted driving systems, such as advanced driver assistance systems (ADAS)) of vehicles may assist a driver of a vehicle. Such driving systems may operate at various levels of autonomy. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions, such as drive in a straight path, stay in a particular lane, control the distance from other vehicles in front of the vehicle, or other functions. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles fully autonomous, self-driving vehicles that operate autonomously in all conditions. A human operator is not needed for the vehicle to take any action.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for assisted driving. According to at least one example, a method is provided for assisted driving. The method includes: comparing a steering output signal to a measured steering signal, wherein the steering output signal is generated by a driving system of a vehicle and output to a steering system of the vehicle, and wherein the measured steering signal is based on a steering angle of a vehicle; and based on a difference between the measured steering signal and the steering output signal exceeding a threshold, generating a driver-is-interacting signal for indicating that a driver is interacting with one or more controls of the vehicle.

In another example, an apparatus for assisted driving is provided that includes at least one memory and at least one processor (e.g., configured in circuitry) coupled to the at least one memory. The at least one processor configured to: compare a steering output signal to a measured steering signal, wherein the steering output signal is generated by a driving system of a vehicle and output to a steering system of the vehicle, and wherein the measured steering signal is based on a steering angle of a vehicle; and based on a difference between the measured steering signal and the steering output signal exceeding a threshold, generate a driver-is-interacting signal for indicating that a driver is interacting with one or more controls of the vehicle.

In another example, a non-transitory computer-readable medium is provided that has stored thereon instructions that, when executed by one or more processors, cause the one or more processors to: compare a steering output signal to a measured steering signal, wherein the steering output signal is generated by a driving system of a vehicle and output to a steering system of the vehicle, and wherein the measured steering signal is based on a steering angle of a vehicle; and based on a difference between the measured steering signal and the steering output signal exceeding a threshold, generate a driver-is-interacting signal for indicating that a driver is interacting with one or more controls of the vehicle.

In another example, an apparatus for assisted driving is provided. The apparatus includes: means for comparing a steering output signal to a measured steering signal, wherein the steering output signal is generated by a driving system of a vehicle and output to a steering system of the vehicle, and wherein the measured steering signal is based on a steering angle of a vehicle; and means for based on a difference between the measured steering signal and the steering output signal exceeding a threshold, generating a driver-is-interacting signal for indicating that a driver is interacting with one or more controls of the vehicle.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example system of a vehicle for determining whether a driver is interacting with controls of the vehicle, according to various aspects of the present disclosure;

FIG. 2 includes a graph of various steering signals according to an example scenario;

FIG. 3 includes a graph of various steering signals according to another example scenario to provide context for a description of a technique for determining whether a driver is interacting with controls of a vehicle, according to various aspects of the present disclosure;

FIG. 4 includes a graph of various steering signals according to another example scenario to provide context for a description of a technique for determining whether a driver is interacting with controls of a vehicle, according to various aspects of the present disclosure;

FIG. 5 includes a graph of various steering signals according to another example scenario to provide context for a description of a technique for determining whether a driver is interacting with controls of a vehicle, according to various aspects of the present disclosure;

FIG. 6 includes a graph of various steering signals according to another example scenario to provide context for a description of a technique for determining whether a driver is interacting with controls of a vehicle, according to various aspects of the present disclosure;

FIG. 7 includes a graph of various steering signals according to another example scenario to provide context for a description of a technique for determining whether a driver is interacting with controls of a vehicle, according to various aspects of the present disclosure;

FIG. 8 includes a graph of various steering signals according to another example scenario to provide context for a description of a technique for determining whether a driver is interacting with controls of a vehicle, according to various aspects of the present disclosure;

FIG. 9 is a hybrid block-diagram flow-diagram illustrating an example process for determining whether a driver is interacting with controls (e.g., a steering wheel) of a vehicle, according to various aspects of the present disclosure;

FIG. 10 is a flow diagram illustrating an example process for determining whether a driver is interacting with controls of a vehicle, in accordance with aspects of the present disclosure;

FIG. 11 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As mentioned above, driving systems (e.g., autonomous, semi-autonomous, and/or assisted driving systems, such as advanced driver assistance systems (ADAS)) of vehicles may assist a driver of a vehicle. Such driving systems may operate at various levels of autonomy. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions, such as drive in a straight path, stay in a particular lane, control the distance from other vehicles in front of the vehicle, or other functions. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles fully autonomous, self-driving vehicles that operate autonomously in all conditions. A human operator is not needed for the vehicle to take any action.

ADAS level 2 and level 3, for example, have features that behave differently based on whether a human (e.g., driver) is interacting with controls of a vehicle (e.g., attempting to steer the vehicle) or not. It may be important for an ADAS to be able to determine whether a human is interacting with controls of a vehicle.

Systems, apparatuses, methods (also referred to as processes), and computer-readable media (collectively referred to herein as “systems and techniques”) are described herein for determining when a human (e.g., a driver) is interacting with controls of a vehicle (e.g., steering the vehicle). For example, the systems and techniques may compare a steering output signal to a measured steering signal. The steering output signal may be generated by a driving system of a vehicle and output to a steering system of the vehicle. The measured steering signal may be based on a steering angle of a vehicle. The systems and techniques may, based on a difference between the measured steering signal and the steering output signal exceeding a threshold, output a driver-is-interacting signal.

In some aspects, the systems and techniques may adjust an operating parameter of the vehicle based the driver-is-interacting signal. The operating parameter may be associated with, for example, a path for the vehicle to travel, a steering parameter for operating steering of the vehicle, a braking parameter for operating brakes of the vehicle, a lane-change parameter for causing the vehicle to navigate from a first lane to a second lane, and/or displaying information related to steering the vehicle using a user interface of the vehicle

Various aspects of the application will be described with respect to the figures below.

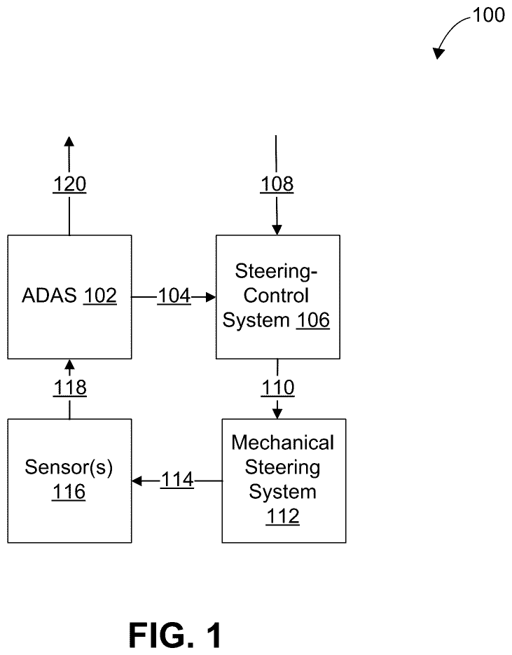

FIG. 1 is a block diagram illustrating an example system 100 of a vehicle for determining whether a driver is interacting with controls of the vehicle, according to various aspects of the present disclosure. In general, an autonomous, semi-autonomous, or assisted driving systems, which may be referred to as an advanced driver assistance systems (ADAS) 102 may send a steering output signal 104 to steering-control system 106 (e.g., based on a destination to which ADAS 102 is driving a vehicle). Steering-control system 106 may generate a control signal 110 based on steering output signal 104 and user input 108. Steering-control system 106 may provide control signal 110 to mechanical steering system 112. Mechanical steering system 112 may implement control signal 110, for example, by controlling actuators based on control signal 110. Sensor(s) 116 may take measurements 114 of mechanical steering system 112 and determine measured steering signal 118 based on the measurements. Sensor(s) 116 may provide measured steering signal 118 to ADAS 102. ADAS 102 may determine, generate, and/or output driver-is-interacting signal 120 based on steering output signal 104 and measured steering signal 118.

ADAS 102 may be, or may include, a computing system of a vehicle. ADAS 102 may implement assisted or autonomous driving operations according to any level of autonomy. For example, ADAS 102 may control steering, acceleration, and/or braking of a vehicle. For instance, ADAS 102 may generate control signals (e.g., steering output signal 104) and provide the control signals to various other systems of the vehicle (e.g., steering-control system 106, a braking system, and/or an accelerator system).

ADAS 102 may generate steering output signal 104 and provide steering output signal 104 to steering-control system 106. In some aspects, steering output signal 104 may be, or may include, a pinion-angle request. Alternatively, steering output signal 104 may be, or may include, a curvature request. In some aspects, steering output signal 104 may be, or may include, a request or instruction the vehicle to follow a certain trajectory. This request could be a direct request towards the steering, or an indirect request like a curvature request. A curvature request may be, or may include, a request to follow a trajectory from an abstract vehicle perspective.

Steering output signal 104 may be a continuous signal. For example, steering output signal 104 may be, or may include, a signal continuously having a voltage level. Additionally or alternatively, steering output signal 104 may include one or more values stored in memory. Steering output signal 104 may continuously indicate an angle for a pinion of the vehicle or an angle for wheels of the vehicle. Steering-control system 106 may sample steering output signal 104 or read steering output signal 104 from memory at any suitable rate.

Steering-control system 106 may be, or may include, a computing system, or portion of a computing system (e.g., one or more modules of ADAS 102), configured to generate control signal 110 to control steering of the vehicle. Steering-control system 106 may translate steering output signal 104 into an electrical signal to control actuators of mechanical steering system 112. In some aspects (e.g., aspects in which ADAS 102 provides steering output signal 104 in the form of a curvature request), steering-control system 106 (or another system) may translate the curvature request into an angle request. In some aspects, control signal 110 may be, or may include, a torque request to an electronic power steering motor. In some aspects, control signal 110 may be, or may include, a request to individual electric motors of the vehicle.

Additionally, steering-control system 106 may receive user input 108 (e.g., from a steering wheel of the vehicle). Steering-control system 106 may generate control signal 110 based on user input 108.

Mechanical steering system 112 may be, or may include, mechanical components that mechanically control steering of the vehicle. Mechanical steering system 112 may be, or may include, a steering column, a rack-and-pinion system, a steering box, idler arms, drop arms, power-steering actuators, etc.

Sensor(s) 116 may take measurements 114 based on mechanical steering system 112. Measurements 114 may be, or may include, measurements of a pinion angle and/or a wheel angle. Sensor(s) 116 may be, or may include, any suitable sensor for measuring the pinion angle and/or wheel angle. For example, sensor(s) 116 may include sensors in the rack-and-pinion system of a vehicle configured to measure a pinion angle and/or wheel angle. Additionally or alternatively, sensor(s) 116 may include one or more cameras positioned to capture images a road on which the vehicle is travelling. Sensor(s) 116 may determine a road-based curvature based on the images of the road.

In the present disclosure, the terms “wheel angle,” “angle of the wheels,” and like terms, may refer to a direction orthogonal to an axis wheel, (e.g., a direction in which the wheel may roll). The wheel angle may be relative to a direction the vehicle is facing. For example, a wheel angle of 0 may indicate the wheel is pointing in line with the direction the vehicle is facing, such that if the wheel rolls, the vehicle will roll straight forward. Similarly, the term “pinion angle” may refer to an angle of one or more components of mechanical steering system 112. The pinion angle may likewise be indicative of a direction wheels of the vehicle may roll. The term “road-based curvature” may refer to the curvature the vehicle is following with respect to the curvature of the road based path it should follow. For example, a road-based curvature of 0 may indicate a straight road based path in line with the direction the vehicle is facing, such that if the vehicle moved, the vehicle will move straight forward.

Sensor(s) 116 may provide measured steering signal 118 to ADAS 102. Measured steering signal 118 may be a continuous signal. For example, measured steering signal 118 may be, or may include, a signal continuously having a voltage level. Additionally or alternatively, measured steering signal 118 may include one or more values stored in memory. Measured steering signal 118 may continuously indicate an angle of the pinion of the vehicle or the angle of the wheels of the vehicle. ADAS 102 may sample measured steering signal 118 or read measured steering signal 118 from memory at any suitable rate.

ADAS 102 may determine when a human (e.g., a driver or potential driver) is interacting with controls of the vehicle. For example, a human may sit in the driver's seat of a vehicle. The human may not be controlling the vehicle, for example, ADAS 102 may be controlling the vehicle. At some point, the human may desire to take control of the vehicle. The human may interact with controls (e.g., an accelerator pedal, a brake pedal, or a steering wheel) of the vehicle. ADAS 102 may determine that the human is interacting with the controls of the vehicle (e.g., to take control of the vehicle). ADAS 102 may cease controlling the vehicle (e.g., the steering, the acceleration, and/or the braking) and allow the human to control the vehicle (e.g., without ADAS 102 generating or providing control signals to a steering-control system 106, a braking system, and/or an accelerator system).

When ADAS 102 determines that the human is interacting with controls of the vehicle, ADAS 102 may determine, generate, and/or output driver-is-interacting signal 120. Driver-is-interacting signal 120 may be a signal, flag, and/or value stored and/or used in ADAS 102 that may indicate that the driver is interacting with controls of the vehicle. Additionally or alternatively, ADAS 102 may output driver-is-interacting signal 120 to another system. Additionally or alternatively, ADAS 102 may cease sending control signals (e.g., steering output signal 104, a braking-control signal, and/or an accelerator control signal) based on generating driver-is-interacting signal 120.

Ceasing to generate or output driver-is-interacting signal 120 may include outputting a predetermined voltage level (e.g., 0 volts) as driver-is-interacting signal 120. Additionally or alternatively, ceasing to generate or output driver-is-interacting signal 120 may include storing a pre-determine value (e.g., 0) in a memory. Similarly, ceasing to generate or output steering output signal 104 may include outputting a predetermined voltage level (e.g., 0 volts) as steering output signal 104. Additionally or alternatively, ceasing to output steering output signal 104 may include storing a pre-determined value (e.g., 0) in a memory from which steering-control system 106 reads steering output signal 104.

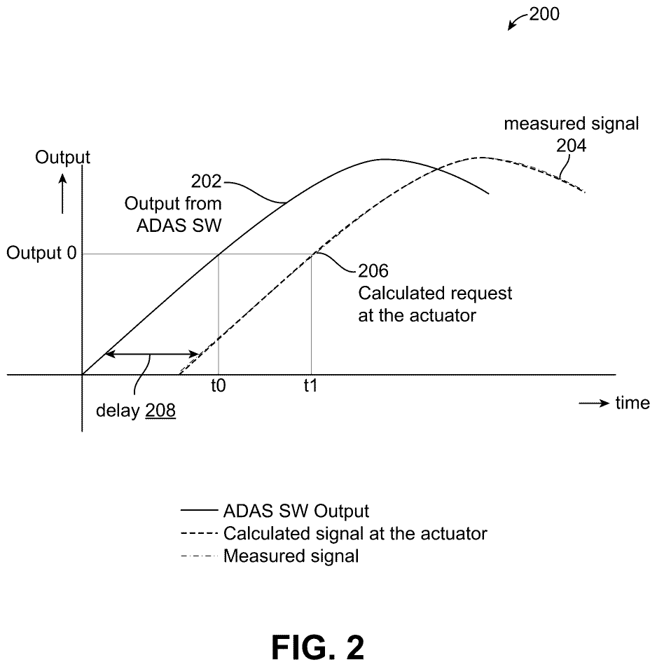

FIG. 2 includes a graph 200 of various steering signals according to an example scenario. For example, graph 200 includes a current steering output signal 202 (which is an example of steering output signal 104 of FIG. 1), a measured steering signal 204 (which is an example of measured steering signal 118), and a steering output signal 206. Steering output signal 206 is an example of control signal 110 as it would be received and applied at mechanical steering system 112, for example after a delay 208, if control signal 110 were based on steering output signal 104 and not based on user input 108). Steering output signal 206 may be current steering output signal 202 delayed by delay 208.

Graph 200 may illustrate an ideal scenario including a constant delay 208 between current steering output signal 202 and the calculated actuator request (e.g., steering output signal 206). In other words, in the scenario of FIG. 2, there is a constant delay between when the steering output signal is output by the ADAS and when the steering output signal is received and applied by the mechanical steering system. In practice, the delay between current steering output signal 202 and the calculated actuator request (e.g., steering output signal 206) may include, as examples, a controller area network (CAN) delay, a calculation time, and an actuator-response time. Meaning the calculated steering output signal 206 at t1 is equal to current steering output signal 202 output at t0 where t0+delay=t1.

The scenario of FIG. 2 may involve no driver interaction. For example, an ADAS (e.g., ADAS 102) may control a vehicle (e.g., without any user input, such as user input 108). In the scenario of FIG. 2, the driver is not interacting with controls of the vehicle, therefore measured steering signal 204 may be the same as steering output signal 206. Further, in the scenario of FIG. 2 there is not noise in the measured signal.

In practice there is noise in measured steering signals. For example, there may be electrical noise between ADAS 102 and mechanical steering system 112. Additionally or alternatively, there may be mechanical noise in controlling wheels of the vehicle, and/or noise based on the wheels traveling on the road. Additionally or alternatively, there may be sensor noise in measuring the angle of the wheels and/or the pinion.

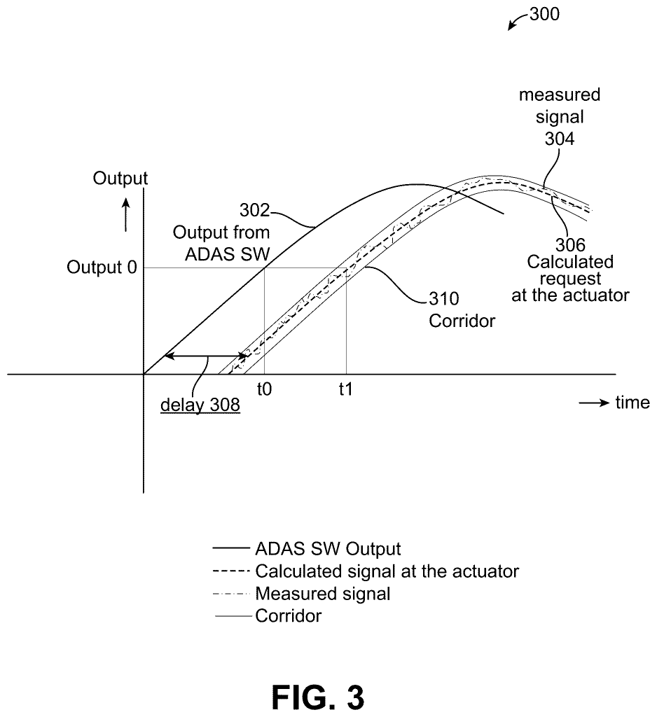

FIG. 3 includes a graph 300 of various steering signals according to another example scenario. The various steering signals of FIG. 3 provide context for a description of a technique for determining whether a driver is interacting with controls of a vehicle, according to various aspects of the present disclosure. Graph 300 includes a current steering output signal 302 (which is an example of steering output signal 104 of FIG. 1), a measured steering signal 304 (which is an example of measured steering signal 118), and a steering output signal 306. Steering output signal 306 is an example of control signal 110 as it would be received and applied at mechanical steering system 112, for example after a delay 208, if control signal 110 were based on steering output signal 104 and not based on user input 108). Steering output signal 306 may be current steering output signal 302 delayed by delay 308.

Current steering output signal 302 may be the same as, or may be substantially similar to, current steering output signal 202. Steering output signal 306 may be the same as, or may be substantially similar to, steering output signal 206. Delay 308 may be the same as, or may be substantially similar to, delay 208.

The scenario of FIG. 3 may involve no driver interaction. For example, an ADAS (e.g., ADAS 102) may control a vehicle (e.g., without any user input, such as user input 108). In the scenario of FIG. 3, the driver is not interacting with controls of the vehicle, therefore measured steering signal 304 may be similar to steering output signal 306. However, in the scenario of FIG. 3 there is noise in the measured signal. For example, measured steering signal 304 may be affected by electrical noise, mechanical noise, road noise, and/or sensor noise. Additionally or alternatively, delay 308 may not be constant. For example, the delay between outputting steering output signal 104 and implementing control signal 110 at mechanical steering system 112 may not be constant.

Referring to FIG. 1, ADAS 102 may determine whether a driver is interacting with controls of a vehicle based on steering output signal 104 and measured steering signal 118. Using the signals of FIG. 3 as examples, ADAS 102 may determine whether a driver is interacting with controls of a vehicle based on current steering output signal 302 and measured steering signal 304.

In order for ADAS 102 to determine whether a driver is interacting with a vehicle based on current steering output signal 302 and measured steering signal 304, ADAS 102 may determine whether measured steering signal 304 stays within a threshold distance of steering output signal 306. Steering output signal 306 is a time-delayed version of current steering output signal 302. ADAS 102 sent steering output signal 306 prior to the current time, thus ADAS 102 has information descriptive of steering output signal 306. Additionally, ADAS 102 may have information indicative of delay 308.

To determine whether a driver is interacting with a vehicle, ADAS 102 may determine whether measured steering signal 304 stays within a corridor 310. Corridor 310 may be defined around steering output signal 306. Corridor 310 may be based on constant value (e.g., a width). The width may of corridor 310 may be determined to be wide enough to cover the real-world inconsistencies (e.g., noises)

Stated another way, ADAS 102 may determine if the difference between measured steering signal 304 and steering output signal 306 is greater than a threshold (e.g., half the width of corridor 310). According to the example scenario of FIG. 3, ADAS 102 may determine that the driver is not interacting with the controls of the vehicle based on measured steering signal 304 staying within corridor 310.

As mentioned above, ADAS 102 may determine steering output signal 306 based on current steering output signal 302 and delay 308. In some aspects, ADAS 102 may determine delay 308 using time stamps of various components. For example, ADAS 102 may timestamp steering output signal 104, steering-control system 106 may timestamp control signal 110 and sensor(s) 116 may timestamp measured steering signal 118. ADAS 102 may determine delay 308 based on the various timestamps.

Additionally or alternatively, ADAS 102 may use a neural-network based-algorithm to determine delay 308 based on current steering output signal 302 and steering output signal 306. For example, a machine-learning model may receive as inputs various delays between current steering output signal 302 and steering output signal 306. The various delays may be captured at various times, for example, under varying circumstances. Once trained, the machine-learning model may output a prediction of delay 308 based on current conditions.

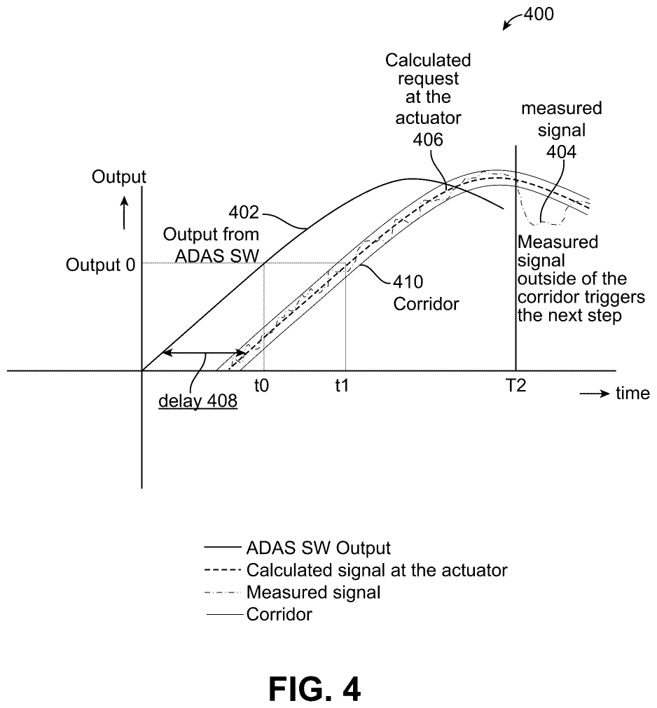

FIG. 4 includes a graph 400 of various steering signals according to another example scenario. The various steering signals of FIG. 4 provide context for a description of a technique for determining whether a driver is interacting with controls of a vehicle, according to various aspects of the present disclosure. Graph 400 includes a current steering output signal 402 (which is an example of steering output signal 104 of FIG. 1), a measured steering signal 404 (which is an example of measured steering signal 118), and a steering output signal 406. Steering output signal 406 is an example of control signal 110 as it would be received and applied at mechanical steering system 112, for example after a delay 408, if control signal 110 were based on steering output signal 104 and not based on user input 108). Steering output signal 406 may be current steering output signal 402 delayed by delay 408.

Current steering output signal 402 may be the same as, or may be substantially similar to, current steering output signal 202. Steering output signal 406 may be the same as, or may be substantially similar to, steering output signal 206. Delay 408 may be the same as, or may be substantially similar to, delay 208. Corridor 410 may be the same as, or may be substantially similar to, corridor 310.

In contrast to FIG. 3, FIG. 4 provides an example of a driver interacting with controls (e.g., a steering wheel) of a vehicle. For example, at, or about, time t2, measured steering signal 404 deviates from steering output signal 406. Steering output signal 406 represents instructions from an ADAS (e.g., ADAS 102). Measured steering signal 404 may deviate from steering output signal 406 based on a driver interacting with a steering wheel (e.g., providing user input 108). For example, referring again to FIG. 1, steering-control system 106 may generate control signal 110 based on steering output signal 104 and/or user input 108. Thus deviations between steering output signal 406 and measured steering signal 404 may be indicative of user input 108.

ADAS 102 may determine that the driver interacted with the steering wheel based on measured steering signal 404 deviating from steering output signal 406. For example, ADAS 102 may determine that the driver interacted with the steering wheel based on measured steering signal 404 going outside corridor 410. In other words, ADAS 102 may determine that the driver interacted with the steering wheel based on a difference between measured steering signal 404 and steering output signal 406 exceeding a threshold. Based on ADAS 102 determining that the driver is interacting with the steering wheel, ADAS 102 may generate and/or output driver-is-interacting signal 120.

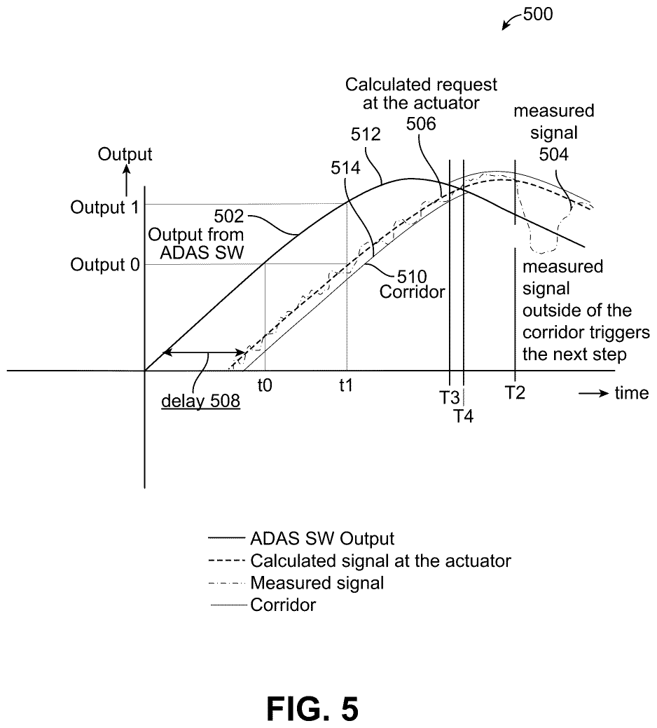

FIG. 5 includes a graph 500 of various steering signals according to another example scenario. The various steering signals of FIG. 5 provide context for a description of a technique for determining whether a driver is interacting with controls of a vehicle, according to various aspects of the present disclosure. Graph 500 includes a current steering output signal 502 (which is an example of steering output signal 104 of FIG. 1), a measured steering signal 504 (which is an example of measured steering signal 118), and a steering output signal 506. Steering output signal 506 is an example of control signal 110 as it would be received and applied at mechanical steering system 112, for example after a delay 508, if control signal 110 were based on steering output signal 104 and not based on user input 108). Steering output signal 506 may be current steering output signal 502 delayed by delay 508.

Current steering output signal 502 may be the same as, or may be substantially similar to, current steering output signal 202. Steering output signal 506 may be the same as, or may be substantially similar to, steering output signal 206. Delay 508 may be the same as, or may be substantially similar to, delay 208.

At any given time, ADAS 102 may have information regarding two steering output signals. For example, at t1, ADAS 102 may have information of calculated actuator request (Output 0) (e.g., the value of steering output signal 506 at t1). Additionally, at t1, ADAS 102 may have information of and the steering request (Output 1) (e.g., the value of current steering output signal 502 at t1).

From the perspective of steering-control system 106 (or mechanical steering system 112), (e.g., from the other side of delay 508) ADAS 102 has information of the current (from the perspective of steering-control system 106 or mechanical steering system 112) actuator request (e.g., steering output signal 506 at t1) and the future request (e.g., current steering output signal 502 at t1).

According to the example of FIG. 5, corridor 510 is extended towards the “future request” For example, at t1, the corridor is extended in the direction of Output 1. This allows the driver to support the feature into the “future” direction without triggering the next step in the driver interaction logic (e.g., without ADAS 102 determining that the driver is taking control of the vehicle). For example, the driver may provide a supportive movement by having hands on the steering wheel as the vehicle turns.

The driver can still trigger the next step in the driver interaction logic when the measured signal leaves the corridor. For example, ADAS 102 may determine that the driver is interacting when, steering output signal 506 crosses the border of the corridor in the opposite direction and/or when steering output signal 506 crosses the extended border of the corridor into the future direction. For example, corridor 510 may be a corridor with a default and symmetric width around steering output signal 506 that is additionally extended in the direction of current steering output signal 502.

For example, ADAS 102 may determine corridor 510 such that a corridor upper bound 512 of corridor 510 is defined by the maximum of current steering output signal 502 and steering output signal 506 plus a predetermined half-width value. For instance, prior to t3, corridor upper bound 512 may be defined by current steering output signal 502 because current steering output signal 502 may be greater than steering output signal 506 plus the default half width of corridor 510. After t3, corridor upper bound 512 may be defined by steering output signal 506 plus the default half width of corridor 510 because the default half width of corridor 510 plus steering output signal 506 may be greater than current steering output signal 502. For example, corridor upper bound 512 may be determined to be a maximum of current steering output signal 502, and steering output signal 506 plus a default half width of corridor 510.

Further, ADAS 102 may determine corridor 510 such that a corridor lower bound 514 of corridor 510 is defined by the minimum of current steering output signal 502 and steering output signal 506 minus the predetermined half width value. For instance, prior to t4, corridor lower bound 514 may be defined by steering output signal 506 minus the default half width of corridor 510 because steering output signal 506 minus the default half width of corridor 510 may be less than current steering output signal 502. After, t4, corridor lower bound 514 may be defined by current steering output signal 502 because current steering output signal 502 may be less than steering output signal 506 minus the default half width of corridor 510. For example, corridor lower bound 514 may be determined to be a minimum of current steering output signal 502 and steering output signal 506 minus a default half width of corridor 510

Stated another way, ADAS 102 may determine corridor upper bound 512 based on a maximum of a constant value and a difference between current steering output signal 502 and steering output signal 506. For example, where the difference between current steering output signal 502 and steering output signal 506 is greater than the default half width of corridor 510 (e.g., prior to t3), corridor upper bound 512 may be current steering output signal 502. Where the difference between current steering output signal 502 and steering output signal 506 is less than the default half width of corridor 510 (e.g., after t3), corridor upper bound 512 may be steering output signal 506 plus the default half width.

Further, ADAS 102 may determine corridor lower bound 514 based on a minimum of a constant value and a difference between current steering output signal 502 and steering output signal 506. For example, where the difference between current steering output signal 502 and steering output signal 506 is less than the default width of corridor 510 (e.g., after t4), corridor lower bound 514 may be current steering output signal 502. Where the difference between current steering output signal 502 and steering output signal 506 is greater than the default width of corridor 510 (e.g., prior to t4), corridor lower bound 514 may be steering output signal 506 minus the default width.

In some cases, the time advantage between t1 and t0 as shown in FIG. 5 may not be sufficient for in curve usage. For example, the calculated corridor may not be wide enough to support slight in-curve steering by the driver (for example, if the driver is riding with their hands on the steering wheel). In some aspects, ADAS 102 may use the information available to ADAS 102 and extend corridor boundary to the curve inside. For example by extrapolating the trend or using the planned trajectory at a further look ahead point.

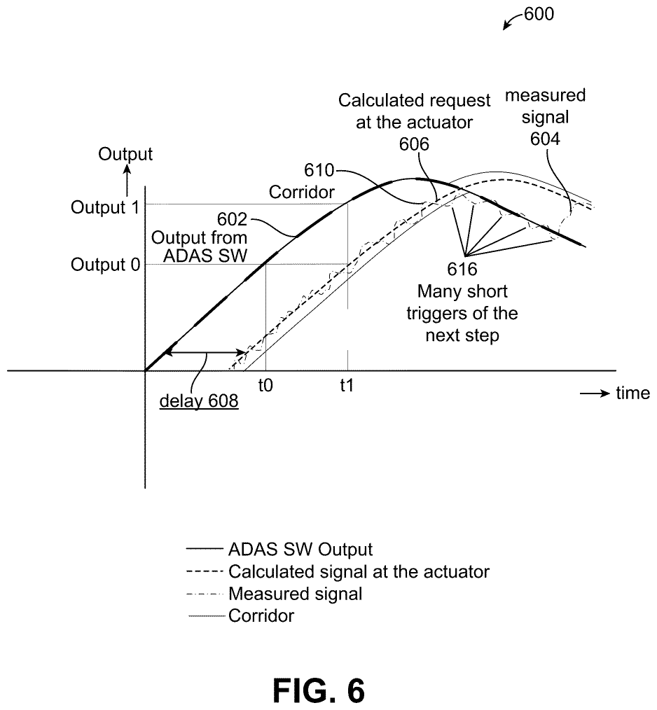

FIG. 6 includes a graph 600 of various steering signals according to another example scenario. The various steering signals of FIG. 6 provide context for a description of a technique for determining whether a driver is interacting with controls of a vehicle, according to various aspects of the present disclosure. Graph 600 includes a current steering output signal 602 (which is an example of steering output signal 104 of FIG. 1), a measured steering signal 604 (which is an example of measured steering signal 118), and a steering output signal 606. Steering output signal 606 is an example of control signal 110 as it would be received and applied at mechanical steering system 112, for example after a delay 608, if control signal 110 were based on steering output signal 104 and not based on user input 108). Steering output signal 606 may be current steering output signal 602 delayed by delay 608.

Current steering output signal 602 may be the same as, or may be substantially similar to, current steering output signal 202. Steering output signal 606 may be the same as, or may be substantially similar to, steering output signal 206. Delay 608 may be the same as, or may be substantially similar to, delay 208. Corridor 610 may be the same as, or may be substantially similar to, corridor 510. However, the issues described with regards to FIG. 6 apply to a corridor such as corridor 310 as well as to a corridor such as corridor 510.

The scenario of FIG. 6 illustrates a case in which steering output signal 606 repeatedly crosses corridor 610. Graph 600 includes crossing points 616 at which steering output signal 606 crosses corridor 610. Steering output signal 606 repeatedly crossing corridor 610 may lead to a flickering driver-is-interacting signal. A flickering driver-is-interacting signal may lead to problems at consumers of the driver-is-interacting signal.

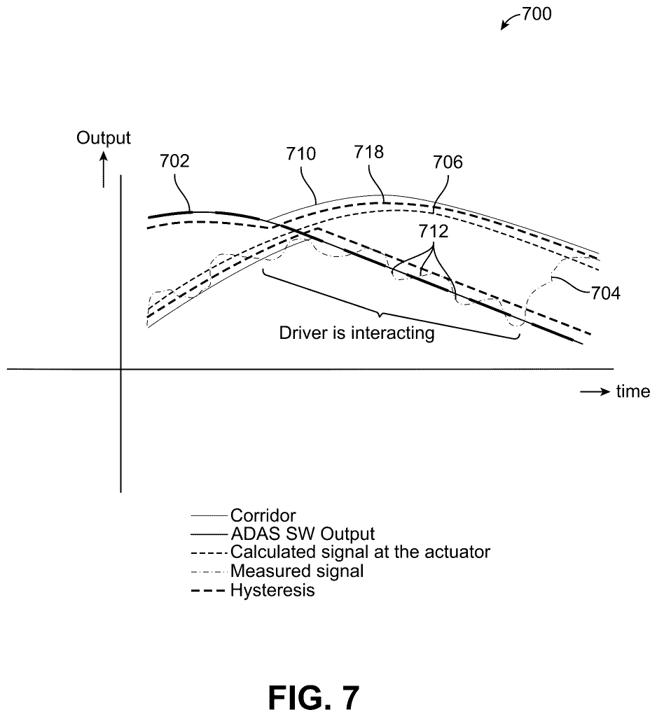

FIG. 7 includes a graph 700 of various steering signals according to another example scenario. The various steering signals of FIG. 7 provide context for a description of a technique for determining whether a driver is interacting with controls of a vehicle, according to various aspects of the present disclosure. In particular, the various steering signals of FIG. 7 provide context for a description of a technique for determining when to cease generating or outputting a driver-is-interacting signal, according to various aspects of the present disclosure.

Graph 700 includes a current steering output signal 702 (which is an example of steering output signal 104 of FIG. 1), a measured steering signal 704 (which is an example of measured steering signal 118), and a steering output signal 706. Steering output signal 706 is an example of control signal 110 as it would be received and applied at mechanical steering system 112, for example after a delay (e.g., delay 208), if control signal 110 were based on steering output signal 104 and not based on user input 108). Steering output signal 706 may be current steering output signal 702 delayed by a delay (not illustrated in FIG. 7).

Current steering output signal 702 may be the same as, or may be substantially similar to, current steering output signal 202. Steering output signal 706 may be the same as, or may be substantially similar to, steering output signal 206. Corridor 710 may be the same as, or may be substantially similar to, corridor 510. However, the issues and techniques described with regards to FIG. 7 apply to a corridor such as corridor 310 as well as to a corridor such as corridor 510.

In order to prevent a driver-is-interacting signal from flickering for example, when measured steering signal 704 repeatedly crosses corridor 710 (e.g., at crossing points 712), ADAS 102 may implement two corridors (e.g., corridor 710 and corridor 718). For example, ADAS 102 may determine when to generate or output the driver-is-interacting signal (or store a value indicative that the driver is interacting) based on measured steering signal 704 being outside corridor 710. ADAS 102 may continue generate or output the driver-is-interacting signal (or store a value indicative that the driver is interacting) until measured steering signal 704 is corridor 718. In other words, ADAS 102 may cease to generate or output the driver-is-interacting signal (or store a value indicative that the driver is not interacting) based on measured steering signal 704 being within corridor 718.

FIG. 7 illustrates several short moments (e.g., at crossing points 712) where measured steering signal 704 crosses corridor 710. The technique illustrated by FIG. 7, adds a hysteresis to corridor 710. The boundary to deactivate the driver-is-interacting signal can be set lower than corridor 710 (e.g., corridor 718 is smaller than corridor 710).

The hysteresis will add robustness by, for example, making it harder to deactivate driver-is-interacting signal by lowering the threshold. In some aspects, with corridor 718 implemented, the threshold to activate driver-is-interacting signal may be increased (e.g., corridor 710 may be widened).

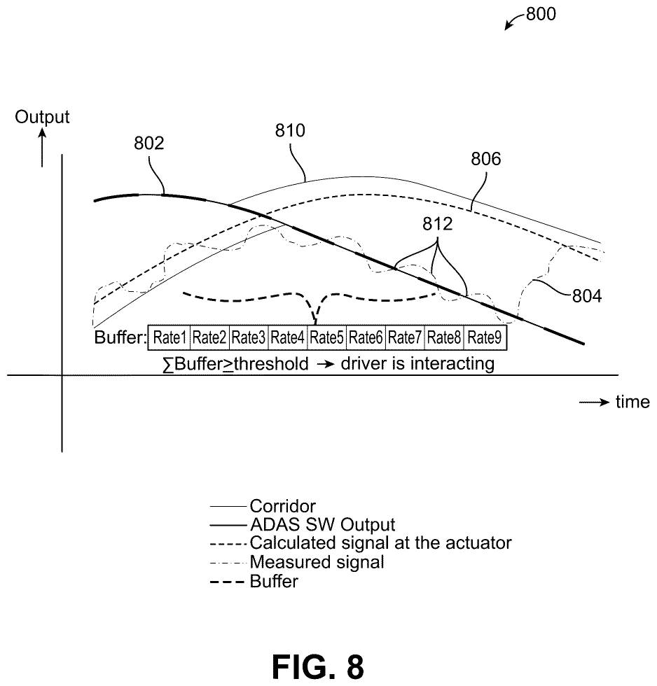

In some aspects, there may be different thresholds for different use cases and/or different downstream functions. For example, the systems and techniques may determine the driver-is-interacting signal using different thresholds for different downstream functions. For example, a first downstream function may expect the driver-is-interacting to be relatively sensitive to the driver. Therefore, the systems and techniques may apply a shorter or narrower hysteresis and/or a narrower corridor. In contrast, a second downstream function may expect the driver-is-interacting signal to be more robust. Therefore, the systems and techniques may apply a longer and/or wider hysteresis and/or a wider corridor. In some cases, the systems and techniques may generate multiple different driver-is-interacting signals at the same time. For example, the systems and techniques may determine a first driver is interacting signal based on a first default corridor width, a first hysteresis length, and first hysteresis width. Further, the systems and techniques may determine a second driver is interacting signal based on a second default corridor width, a second hysteresis length, and second hysteresis width. FIG. 8 includes a graph 800 of various steering signals according to another example scenario. The various steering signals of FIG. 8 provide context for a description of a technique for determining whether a driver is interacting with controls of a vehicle, according to various aspects of the present disclosure. In particular, the various steering signals of FIG. 8 provide context for a description of a technique for determining when to cease generating or outputting a driver-is-interacting signal, according to various aspects of the present disclosure.

Graph 800 includes a current steering output signal 802 (which is an example of steering output signal 104 of FIG. 1), a measured steering signal 804 (which is an example of measured steering signal 118), and a steering output signal 806. Steering output signal 806 is an example of control signal 110 as it would be received and applied at mechanical steering system 112, for example after a delay (e.g., delay 208), if control signal 110 were based on steering output signal 104 and not based on user input 108). Steering output signal 806 may be current steering output signal 802 delayed by a delay (not illustrated in FIG. 8).

Current steering output signal 802 may be the same as, or may be substantially similar to, current steering output signal 202. Steering output signal 806 may be the same as, or may be substantially similar to, steering output signal 806. Corridor 810 may be the same as, or may be substantially similar to, corridor 510. However, the issues and techniques described with regards to FIG. 8 apply to a corridor such as corridor 310 as well as to a corridor such as corridor 510.

In order to prevent a driver-is-interacting signal from flickering for example, when measured steering signal 804 repeatedly crosses corridor 810 (e.g., at crossing points 812), ADAS 102 may determine the rate of change of measured steering signal 804 at various points. ADAS 102 may store the rates of change in a ring buffer. Further, ADAS 102 may sum the rates of change stored in the ring buffer and determine whether the sum exceeds a threshold. If the sum of the rates of change exceeds the threshold, ADAS 102 may determine to output, or continue to output, the driver-is-interacting signal (or to store a value indicating that the driver is interacting in memory). If the sum of the rates of change does not exceed the threshold, ADAS 102 may determine to cease outputting, the driver-is-interacting signal (or to store a value indicating that the driver is not interacting in the memory.

FIG. 8 illustrates several short moments (e.g., at crossing points 812) where measured steering signal 804 crosses corridor 810. ADAS 102 may determine to output the driver-is-interacting signal based on observing the rate of change of measured steering signal 804 over time. Once the sum of the rates of change crosses a threshold, ADAS 102 may determine that the driver is interacting with the controls of the vehicle. ADAS 102 may store the rates of change in a ring buffer, for example. ADAS 102 may continue to output the driver-is-interacting signal until the sum of rates of change no longer exceeds the threshold.

The rates-of-change technique of FIG. 8 may cause ADAS 102 to determine whether the driver is interacting based on the severity of the driver interaction. For example, a high-rate interaction (e.g., a sudden jerk of the steering wheel) will sooner cross the set threshold than a low-rate interaction over the same amount of time. Also a low-rate interaction over a longer period of time will eventually be recognized as a driver interaction.

In some aspects, there may be different thresholds for different use cases and/or different customer functions.

Once the driver interaction begins changing in direction, the sum of the buffer values in will decrease. In some cases, it the sum of the buffer values may not decrease fast enough and may still include residual values once the opposite boundary of the corridor is being crossed. To prevent ADAS 102 from sticking to values from the opposite direction, a reset may be determined to reset values in the buffer once the measured signal crosses the calculated actuator response. For example, ADAS 102 may reset values in the ring buffer when measured steering signal 804 crosses steering output signal 806.

In some aspects, the driver-is-interacting signal may be binary. For example, the driver-is-interacting signal may be interpretable as an indication that either the driver is interacting with controls of the vehicle, or the driver is not interacting with the controls of the vehicle. For example, ADAS 102 may set the driver-is-interacting signal with one of two voltage levels. Additionally or alternatively, ADAS 102 may store one of two values (e.g., a 1 or a 0).

In other aspects, the driver-is-interacting signal may be non-binary. For example, the driver is interacting signal may be interpretable as an indication of a percentage of driver interactions or a likelihood of driver interactions. For example, ADAS 102 may set ADAS 102 at a voltage level between a voltage maximum and a voltage minimum. Additionally or alternatively, ADAS 102 may store a floating-point value between 0 and 1.

As one illustrative example, according to the technique described with regard to FIG. 8, ADAS 102 may determine the percentage of driver interaction (or the likelihood of driver interaction) based on the sum of the rates of change in the ring buffer. For example, the driver-is-interacting signal may be a ratio between the sum of the rates of change in the ring buffer and a threshold.

In some aspects, the threshold may be tuned according to the one or more downstream functions. For instance, the threshold may be tuned based on an average of one or more downstream functions. Additionally or alternatively, there may be multiple thresholds tuned for multiple respective downstream functions. As an example, the driver-is-interacting percentage may be used as an input to an example downstream function. The percentage boundary may be determined based on the example downstream function. For example, an example downstream function may use a more sensitive signal. Accordingly, a lower percentage boundary may be used by ADAS 102 to determine the driver-is-interacting percentage. For instance, a downstream function 1 may detect driver-is-interacting at 50%, whereas a downstream function 2 may be less sensitive and may detects driver-is-interacting at 80%.

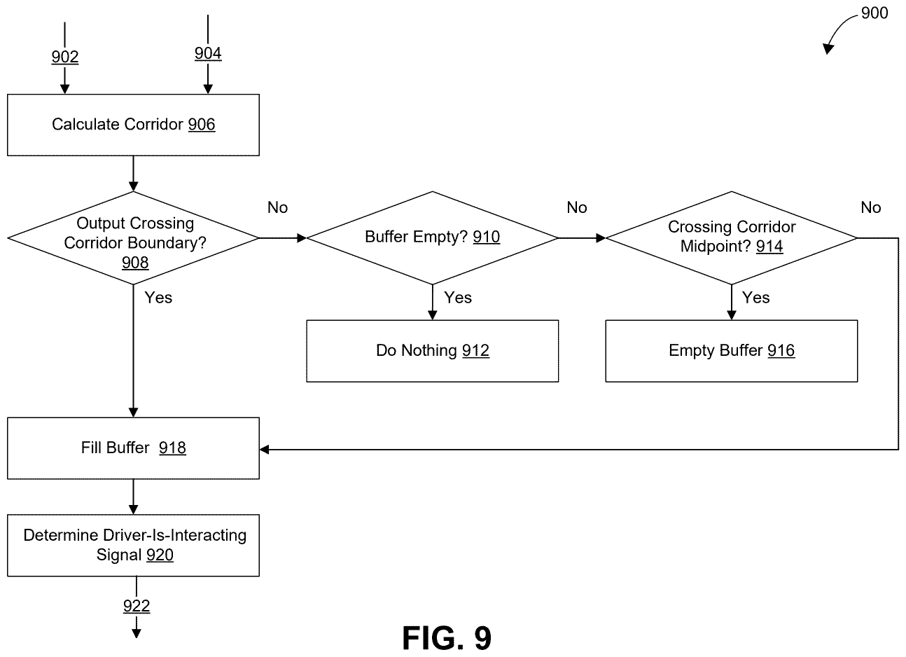

FIG. 9 is a hybrid block-diagram flow-diagram illustrating an example process 900 for determining whether a driver is interacting with controls (e.g., a steering wheel) of a vehicle, according to various aspects of the present disclosure. Process 900 may be performed by an ADAS (e.g., ADAS 102).

The ADAS may obtain steering output signal 902 and measured steering signal 904. steering output signal 902 may be an example of steering output signal 104. Measured steering signal 904 may be an example of measured steering signal 118. The ADAS may generate and/or output driver-is-interacting signal 922. Driver-is-interacting signal 922 may be an example of driver-is-interacting signal 120 of FIG. 1.

Process 900 may be repeated at a sampling rate. For example, the ADAS may sample steering output signal 902 and measured steering signal 904. For each sampled instance of steering output signal 902 and measured steering signal 904, the ADAS may perform process 900 to generate a value for driver-is-interacting signal 922.

At block 906, the ADAS may calculate a corridor based on steering output signal 902. For example, the ADAS may obtain a delay (e.g., delay 308 of FIG. 3). The ADAS may be provided with the delay. Additionally or alternatively, the ADAS may determine the delay, for example based on timestamps. Additionally or alternatively, the ADAS may use a neural-network based algorithm to determine the delay.

After determining the delay, the ADAS may determine a delayed instance of steering output signal 902. For example, the ADAS may determine steering output signal 306 based on current steering output signal 302 and delay 308.

Further, the ADAS may determine a corridor based on the delayed instance of steering output signal 902. In some aspects, the ADAS may determine the corridor based on a pre-determined width around the delayed instance of steering output signal 902. For example, the ADAS may determine corridor 310 based on steering output signal 306. In other aspects, the ADAS may determine the corridor based on maximums and minimums of the delayed instance of steering output signal 902 and the pre-determined width. For example, the ADAS may determine corridor 510 based on steering output signal 506.

At decision block 908, the ADAS may determine whether measured steering signal 904 is outside a boundary of the corridor. If measured steering signal 904 is outside the corridor, process 900 may proceed to block 918. If 904 is inside the corridor, process 900 may proceed to decision block 910.

At decision block 910, the ADAS may determine whether a buffer (e.g., a ring buffer) is empty. If the ring buffer is empty, process 900 may proceed to block 912. At block 912, process 900 may do nothing. Process 900 may be repeated when steering output signal 902 and measured steering signal 904 are subsequently sampled. However, if the buffer is not empty, process 900 may proceed to decision block 914.

At decision block 914, the ADAS may determine whether measured steering signal 904 has crossed a midpoint of the corridor determined at block 906. For example, the ADAS may determine which side of a midpoint of the corridor measured steering signal 904 is on. Further, the ADAS may determine which side of the midpoint of the corridor a prior sampled value of measured steering signal 904 was on. If the current sampled value of measured steering signal 904 is on the opposite side of the midpoint from the prior sampled value of measured steering signal 904, measured steering signal 904 has crossed the midpoint. If measured steering signal 904 has crossed the midpoint of the corridor, process 900 may proceed to block 916. At block 916, the ADAS may empty the buffer. However, if measured steering signal 904 has not crossed the midpoint of the corridor, process 900 may proceed to block 918.

At block 918, the ADAS may add a rate of change of measured steering signal 904 (e.g., the difference between a prior sampled value of measured steering signal 904 and a current sampled value of measured steering signal 904) in the ring buffer. After storing the value of the rate of change in the ring buffer, process 900 may proceed to steering output signal 902.

At block 920, the ADAS may determine driver-is-interacting signal 922. The ADAS may determine a value of driver-is-interacting signal 922 for each sampled value of steering output signal 902 and measured steering signal 904 obtained.

In some aspects, at block 920, the ADAS may determine driver-is-interacting signal 922 based on whether a sum of values in the buffer exceeds a threshold.

In some aspects, at block 920, the ADAS may determine driver-is-interacting signal 922 based on only a single sampled value of steering output signal 902 and a single sampled value of measured steering signal 904. For example, the ADAS may determine driver-is-interacting signal 922 as if the buffer size was one.

In some aspects, driver-is-interacting signal 922 may be binary. In other aspects, driver-is-interacting signal 922 may be non-binary. For example, driver-is-interacting signal 922 may be, or may include, a value between 0 and 1.

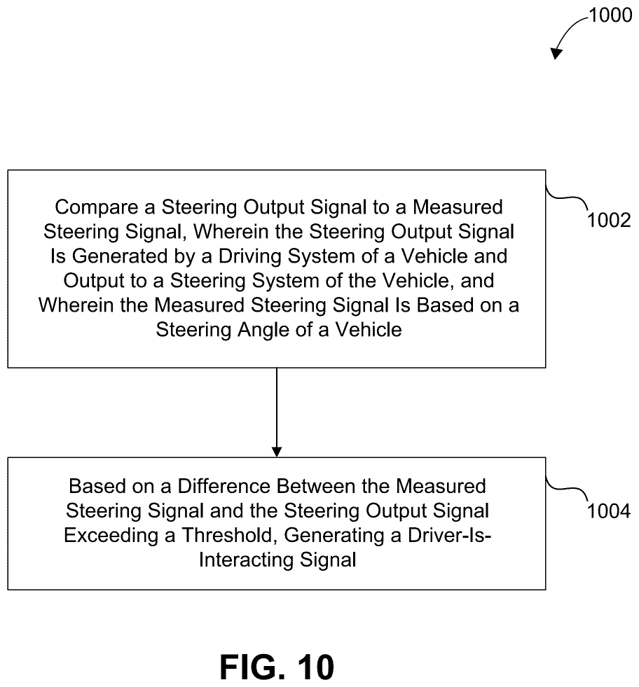

FIG. 10 is a flow diagram illustrating an example process 1000 for determining whether a driver is interacting with controls of a vehicle, in accordance with aspects of the present disclosure. One or more operations of process 1000 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1000. The one or more operations of process 1000 may be implemented as software components that are executed and run on one or more processors.

At block 1002, a computing device (or one or more components thereof) may compare a steering output signal to a measured steering signal, wherein the steering output signal is generated by a driving system of a vehicle and output to a steering system of the vehicle, and wherein the measured steering signal is based on a steering angle of a vehicle. For example, ADAS 102 may compare steering output signal 104 (e.g., delayed) to measured steering signal 118. Steering output signal 104 may be generated by ADAS 102 and provided to steering-control system 106 to control steering of a vehicle. Measured steering signal 118 may be based on a steering angle of the vehicle.

In some aspects, the steering output signal is delayed such that the steering output signal is related to a time at which the measured steering signal is measured. For example, ADAS 102 may compare a delayed version of steering output signal 104 with measured steering signal 118. The delayed version of the steering output signal may relate to the steering output signal in substantially the same was that steering output signal 206 relates to 202.

In some aspects, the steering output signal may be, or may include, a pinion angle request; and the measured steering signal may be based on a measured pinion angle. For example, steering output signal 104 may be, or may include, a pinion angle request and measured steering signal 118 may be, or may include, a measured pinion angle.

In some aspects, the steering output signal may be, or may include, a curvature request; and the measured steering signal may be based on a measured wheel angle. For example, steering output signal 104 may be, or may include, a curvature request and measured steering signal 118 may be, or may include, a measured wheel angle.

In some aspects, the steering output signal may be, or may include, a pinion angle request; and the measured steering signal based on a measured wheel angle. For example, steering output signal 104 may be, or may include, a pinion angle request and measured steering signal 118 may be based on a measured wheel angle.

In some aspects, the steering output signal may be, or may include, a curvature request; and the measured steering signal may be based on a measured pinion angle. For example, steering output signal 104 may be, or may include, a curvature request and measured steering signal 118 is based on a measured pinion angle.

At block 1004, the computing device (or one or more components thereof) may, based on a difference between the measured steering signal and the steering output signal exceeding a threshold, generate a driver-is-interacting signal for indicating that a driver is interacting with one or more controls of the vehicle. For example, ADAS 102 may generate output driver-is-interacting signal 120 based on a difference between steering output signal 104 (e.g., delayed) and measured steering signal 118 exceeding a threshold.

In some aspects, the threshold may be, or may include, a constant value. For example, ADAS 102 may determine to output driver-is-interacting signal 120 based on measured steering signal 404 going outside corridor 410 of FIG. 4.

In some aspects, the threshold is based on a current steering output signal output by the driving system to the steering system. For example, ADAS 102 may determine corridor 510 based on current steering output signal 502 of FIG. 5. For instance, ADAS 102 may determine to output driver-is-interacting signal 120 based on measured steering signal 504 going outside corridor 510.

In some aspects, the threshold may be, or may include: a maximum of a difference between the current steering output signal and the steering output signal and a constant value; and a minimum of a difference between the current steering output signal and the steering output signal and a constant value. For example, ADAS 102 may determine corridor 510 based on current steering output signal 502 of FIG. 5. For instance, ADAS 102 may determine to output driver-is-interacting signal 120 based on measured steering signal 504 going outside corridor 510. Corridor 510 includes corridor upper bound 512 defined based on a maximum of current steering output signal 502 and steering output signal 506 plus a default half width. Additionally, corridor 510 includes corridor lower bound 514 defined based on a minimum of current steering output signal 502 and steering output signal 506 minus a default half width.

In some aspects, the threshold comprises a first threshold, wherein the at least one processor is configured to, based on the difference between the measured steering signal and the steering output signal being within a second threshold, cease to generate the driver-is-interacting signal. For example, ADAS 102 may determine to output driver-is-interacting signal 120 based on measured steering signal 704 exceeding corridor 710. ADAS 102 may determine to cease outputting output driver-is-interacting signal 120 based on measured steering signal 704 being within corridor 718.

In some aspects, the first threshold is larger than the second threshold. For example, corridor 718 is larger than corridor 710.

In some aspects, the threshold comprises a first threshold, wherein the at least one processor is configured to, based on the difference between the measured steering signal and the steering output signal exceeding a second threshold, continue to generate the driver-is-interacting signal. For example, ADAS 102 may determine to output driver-is-interacting signal 120 based on measured steering signal 704 exceeding corridor 710. In some aspects, ADAS 102 may continue outputting output driver-is-interacting signal 120 based on measured steering signal 704 being exceeding corridor 718.

In some aspects, the threshold comprises a first threshold. The computing device (or one or more components thereof) may at a plurality of times, determine a corresponding plurality of rates of change based on the measured steering signal; and based on a sum of the plurality of rates of change being less than a second threshold, cease to generate the driver-is-interacting signal. For example, ADAS 102 may determine a rate of measured steering signal 804 at a number of times. ADAS 102 may sum the plurality of rates of change. If the sum of the rates of change is less than a threshold, ADAS 102 may cease outputting output driver-is-interacting signal 120 (e.g., as described with regard to FIG. 8).

In some aspects, the threshold comprises a first threshold. The computing device (or one or more components thereof) may at a plurality of times, determine a corresponding plurality of rates of change based on the measured steering signal; and based on a sum of the plurality of rates of change exceeding a second threshold, continue to generate the driver-is-interacting signal. For example, ADAS 102 may determine a rate of measured steering signal 804 at a number of times. ADAS 102 may sum the plurality of rates of change. If the sum of the rates of change exceeds a threshold, ADAS 102 may continue outputting output driver-is-interacting signal 120 (e.g., as described with regard to FIG. 8).

In some aspects, the driver-is-interacting signal is interpretable as a non-binary value. For example, ADAS 102 may generate output driver-is-interacting signal 120 as a non-binary value. Additionally, a downstream consumer may interpret output driver-is-interacting signal 120 as a non-binary signal.

In some aspects, the computing device (or one or more components thereof) may be, or may include, a computing system of a vehicle. In some aspects, the computing device (or one or more components thereof) may adjust an operating parameter of the vehicle based the driver-is-interacting signal.

In some aspects, the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to steering the vehicle using a user interface of the vehicle.

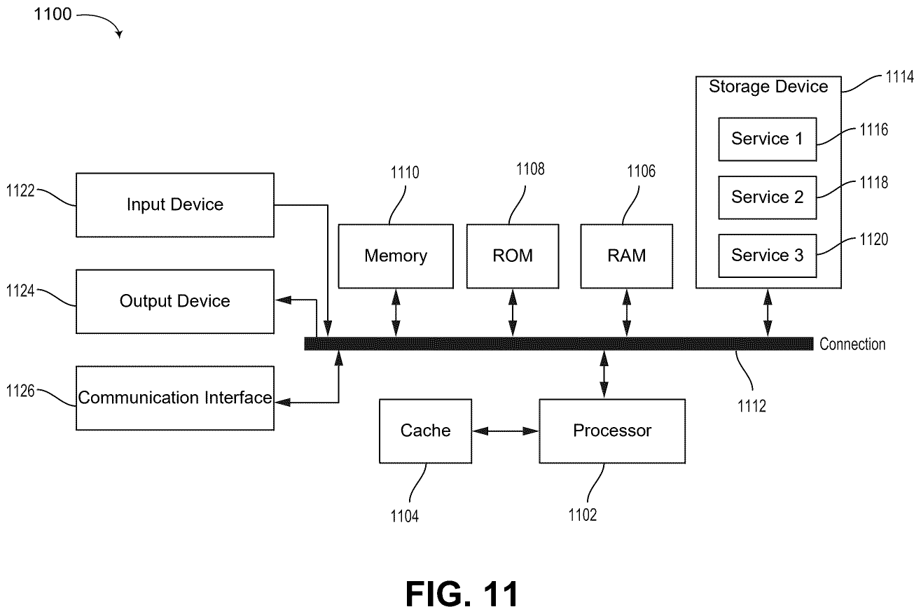

In some examples, as noted previously, the methods described herein (e.g., process 900 of FIG. 9, process 1000 of FIG. 10, and/or other methods described herein) can be performed, in whole or in part, by a computing device or apparatus. In one example, one or more of the methods can be performed by system 100 of FIG. 1, or by another system or device. In another example, one or more of the methods (e.g., process 900, process 1000, and/or other methods described herein) can be performed, in whole or in part, by the computing-device architecture 1100 shown in FIG. 11. For instance, a computing device with the computing-device architecture 1100 shown in FIG. 11 can include, or be included in, the components of the system 100 and can implement the operations of process 1000, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 900, process 1000, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 900, process 1000, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 11 illustrates an example computing-device architecture 1100 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1100 may include, implement, or be included in any or all of system 100 of FIG. 1 and/or other devices, modules, or systems described herein. Additionally or alternatively, computing-device architecture 1100 may be configured to perform process 900 of FIG. 9, process 1000 of FIG. 10, and/or other process described herein.

The components of computing-device architecture 1100 are shown in electrical communication with each other using connection 1112, such as a bus. The example computing-device architecture 1100 includes a processing unit (CPU or processor) 1102 and computing device connection 1112 that couples various computing device components including computing device memory 1110, such as read only memory (ROM) 1108 and random-access memory (RAM) 1106, to processor 1102.

Computing-device architecture 1100 can include a cache of high-speed memory connected directly with, in close proximity to, or integrated as part of processor 1102. Computing-device architecture 1100 can copy data from memory 1110 and/or the storage device 1114 to cache 1104 for quick access by processor 1102. In this way, the cache can provide a performance boost that avoids processor 1102 delays while waiting for data. These and other modules can control or be configured to control processor 1102 to perform various actions. Other computing device memory 1110 may be available for use as well. Memory 1110 can include multiple different types of memory with different performance characteristics. Processor 1102 can include any general-purpose processor and a hardware or software service, such as service 1 1116, service 2 1118, and service 3 1120 stored in storage device 1114, configured to control processor 1102 as well as a special-purpose processor where software instructions are incorporated into the processor design. Processor 1102 may be a self-contained system, containing multiple cores or processors, a bus, memory controller, cache, etc. A multi-core processor may be symmetric or asymmetric.

To enable user interaction with the computing-device architecture 1100, input device 1122 can represent any number of input mechanisms, such as a microphone for speech, a touch-sensitive screen for gesture or graphical input, keyboard, mouse, motion input, speech and so forth. Output device 1124 can also be one or more of a number of output mechanisms known to those of skill in the art, such as a display, projector, television, speaker device, etc. In some instances, multimodal computing devices can enable a user to provide multiple types of input to communicate with computing-device architecture 1100. Communication interface 1126 can generally govern and manage the user input and computing device output. There is no restriction on operating on any particular hardware arrangement and therefore the basic features here may easily be substituted for improved hardware or firmware arrangements as they are developed.

Storage device 1114 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1106, read only memory (ROM) 1108, and hybrids thereof. Storage device 1114 can include services 1116, 1118, and 1120 for controlling processor 1102. Other hardware or software modules are contemplated. Storage device 1114 can be connected to the computing device connection 1112. In one aspect, a hardware module that performs a particular function can include the software component stored in a computer-readable medium in connection with the necessary hardware components, such as processor 1102, connection 1112, output device 1124, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for assisted driving, the apparatus comprising: at least one memory; and at least one processor coupled to the at least one memory and configured to: compare a steering output signal to a measured steering signal, wherein the steering output signal is generated by a driving system of a vehicle and output to a steering system of the vehicle, and wherein the measured steering signal is based on a steering angle of a vehicle; and based on a difference between the measured steering signal and the steering output signal exceeding a threshold, generate a driver-is-interacting signal for indicating that a driver is interacting with one or more controls of the vehicle.

Aspect 2. The apparatus of aspect 1, wherein the steering output signal is delayed such that the steering output signal is related to a time at which the measured steering signal is measured.

Aspect 3. The apparatus of any one of aspects 1 or 2, wherein: the steering output signal comprises a pinion angle request; and the measured steering signal is based on a measured pinion angle.

Aspect 4. The apparatus of any one of aspects 1 to 3, wherein: the steering output signal comprises a curvature request; and the measured steering signal is based on a measured wheel angle.

Aspect 5. The apparatus of any one of aspects 1 to 4, wherein the threshold comprises a constant value.

Aspect 6. The apparatus of any one of aspects 1 to 5, wherein the threshold is based on a current steering output signal output by the driving system to the steering system.

Aspect 7. The apparatus of aspect 6, wherein the threshold comprises: a maximum of a difference between the current steering output signal and the steering output signal and a constant value; and a minimum of a difference between the current steering output signal and the steering output signal and a constant value.

Aspect 8. The apparatus of any one of aspects 1 to 7, wherein the threshold comprises a first threshold, wherein the at least one processor is configured to, based on the difference between the measured steering signal and the steering output signal being within a second threshold, cease to generate the driver-is-interacting signal.

Aspect 9. The apparatus of aspect 8, wherein the first threshold is larger than the second threshold.

Aspect 10. The apparatus of any one of aspects 1 to 9, wherein the threshold comprises a first threshold, wherein the at least one processor is configured to, based on the difference between the measured steering signal and the steering output signal exceeding a second threshold, continue to generate the driver-is-interacting signal.

Aspect 11. The apparatus of any one of aspects 1 to 10, wherein the threshold comprises a first threshold, wherein the at least one processor is configured to: at a plurality of times, determine a corresponding plurality of rates of change based on the measured steering signal; and based on a sum of the plurality of rates of change being less than a second threshold, cease to generate the driver-is-interacting signal.

Aspect 12. The apparatus of any one of aspects 1 to 11, wherein the threshold comprises a first threshold, wherein the at least one processor is configured to: at a plurality of times, determine a corresponding plurality of rates of change based on the measured steering signal; and based on a sum of the plurality of rates of change exceeding a second threshold, continue to generate the driver-is-interacting signal.

Aspect 13. The apparatus of any one of aspects 1 to 12, wherein the driver-is-interacting signal is interpretable as a non-binary value.

Aspect 14. The apparatus of any one of aspects 1 to 13, wherein the apparatus comprises a computing system of a vehicle.

Aspect 15. The apparatus of aspect 14, wherein the at least one processor is configured to adjust an operating parameter of the vehicle based the driver-is-interacting signal.

Aspect 16. The apparatus of aspect 15, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to steering the vehicle using a user interface of the vehicle.

Aspect 17. A method for assisted driving, the method comprising: comparing a steering output signal to a measured steering signal, wherein the steering output signal is generated by a driving system of a vehicle and output to a steering system of the vehicle, and wherein the measured steering signal is based on a steering angle of a vehicle; and based on a difference between the measured steering signal and the steering output signal exceeding a threshold, generating a driver-is-interacting signal for indicating that a driver is interacting with one or more controls of the vehicle.

Aspect 18. The method of aspect 17, wherein the steering output signal is delayed such that the steering output signal is related to a time at which the measured steering signal is measured.

Aspect 19. The method of any one of aspects 17 or 18, wherein: the steering output signal comprises a pinion angle request; and the measured steering signal is based on a measured pinion angle.

Aspect 20. The method of any one of aspects 17 to 19, wherein: the steering output signal comprises a curvature request; and the measured steering signal is based on a measured wheel angle.

Aspect 21. The method of any one of aspects 17 to 20, wherein the threshold comprises a constant value.

Aspect 22. The method of any one of aspects 17 to 21, wherein the threshold is based on a current steering output signal output by the driving system to the steering system.

Aspect 23. The method of aspect 22, wherein the threshold comprises: a maximum of a difference between the current steering output signal and the steering output signal and a constant value; and a minimum of a difference between the current steering output signal and the steering output signal and a constant value.

Aspect 24. The method of any one of aspects 17 to 23, wherein the threshold comprises a first threshold, the method further comprising, based on the difference between the measured steering signal and the steering output signal being within a second threshold, ceasing to generate the driver-is-interacting signal.

Aspect 25. The method of aspect 24, wherein the first threshold is larger than the second threshold.

Aspect 26. The method of any one of aspects 17 to 25, wherein the threshold comprises a first threshold, the method further comprising, based on the difference between the measured steering signal and the steering output signal exceeding a second threshold, continuing to generate the driver-is-interacting signal.

Aspect 27. The method of any one of aspects 17 to 26, wherein the threshold comprises a first threshold, the method further comprising: at a plurality of times, determining a corresponding plurality of rates of change based on the measured steering signal; and based on a sum of the plurality of rates of change being less than a second threshold, ceasing to generate the driver-is-interacting signal.

Aspect 28. The method of any one of aspects 17 to 27, wherein the threshold comprises a first threshold, the method further comprising: at a plurality of times, determining a corresponding plurality of rates of change based on the measured steering signal; and based on a sum of the plurality of rates of change exceeding a second threshold, continuing to generate the driver-is-interacting signal.

Aspect 29. The method of any one of aspects 17 to 28, wherein the driver-is-interacting signal is interpretable as a non-binary value.

Aspect 30. The method of any one of aspects 17 to 29, further comprising adjusting an operating parameter of the vehicle based the driver-is-interacting signal.

Aspect 31. The method of aspect 30, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to steering the vehicle using a user interface of the vehicle.

Aspect 32. A non-transitory computer-readable storage medium having stored thereon instructions that, when executed by at least one processor, cause the at least one processor to perform operations according to any of aspects 17 to 31.

Aspect 33. An apparatus for assisted driving, the apparatus comprising one or more means for perform operations according to any of aspects 17 to 31.

What is claimed is:

1. An apparatus for assisted driving, the apparatus comprising:
at least one memory; and
at least one processor coupled to the at least one memory and configured to:
compare a steering output signal to a measured steering signal, wherein the steering output signal is generated by a driving system of a vehicle and output to a steering system of the vehicle, and wherein the measured steering signal is based on a steering angle of a vehicle; and
based on a difference between the measured steering signal and the steering output signal exceeding a threshold, generate a driver-is-interacting signal for indicating that a driver is interacting with one or more controls of the vehicle.

2. The apparatus of claim 1, wherein the steering output signal is delayed such that the steering output signal is related to a time at which the measured steering signal is measured.

3. The apparatus of claim 1, wherein:
the steering output signal comprises a pinion angle request; and
the measured steering signal is based on a measured pinion angle.

4. The apparatus of claim 1, wherein:
the steering output signal comprises a curvature request; and
the measured steering signal is based on a measured wheel angle.

5. The apparatus of claim 1, wherein:
the steering output signal comprises a curvature request; and
the measured steering signal is based on a measured curvature.

6. The apparatus of claim 1, wherein the threshold comprises a constant value.

7. The apparatus of claim 1, wherein the threshold is based on a current steering output signal output by the driving system to the steering system.

8. The apparatus of claim 7, wherein the threshold comprises:
a maximum of a difference between the current steering output signal and the steering output signal and a constant value; and
a minimum of a difference between the current steering output signal and the steering output signal and a constant value.

9. The apparatus of claim 1, wherein the threshold comprises a first threshold, wherein the at least one processor is configured to, based on the difference between the measured steering signal and the steering output signal being within a second threshold, cease to generate the driver-is-interacting signal.

10. The apparatus of claim 9, wherein the first threshold is larger than the second threshold.

11. The apparatus of claim 1, wherein the threshold comprises a first threshold, wherein the at least one processor is configured to, based on the difference between the measured steering signal and the steering output signal exceeding a second threshold, continue to generate the driver-is-interacting signal.

12. The apparatus of claim 1, wherein the threshold comprises a first threshold, wherein the at least one processor is configured to:
at a plurality of times, determine a corresponding plurality of rates of change based on the measured steering signal; and
based on a sum of the plurality of rates of change being less than a second threshold, cease to generate the driver-is-interacting signal.

13. The apparatus of claim 1, wherein the threshold comprises a first threshold, wherein the at least one processor is configured to:
at a plurality of times, determine a corresponding plurality of rates of change based on the measured steering signal; and
based on a sum of the plurality of rates of change exceeding a second threshold, continue to generate the driver-is-interacting signal.

14. The apparatus of claim 1, wherein the driver-is-interacting signal is interpretable as a non-binary value.

15. The apparatus of claim 1, wherein the apparatus comprises a computing system of a vehicle.

16. The apparatus of claim 15, wherein the at least one processor is configured to adjust an operating parameter of the vehicle based the driver-is-interacting signal.

17. The apparatus of claim 16, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, or displaying information related to steering the vehicle using a user interface of the vehicle.

18. A method for assisted driving, the method comprising:
comparing a steering output signal to a measured steering signal, wherein the steering output signal is generated by a driving system of a vehicle and output to a steering system of the vehicle, and wherein the measured steering signal is based on a steering angle of a vehicle; and
based on a difference between the measured steering signal and the steering output signal exceeding a threshold, generating a driver-is-interacting signal for indicating that a driver is interacting with one or more controls of the vehicle.

19. The method of claim 18, wherein the steering output signal is delayed such that the steering output signal is related to a time at which the measured steering signal is measured.

20. The method of claim 18, wherein:
the steering output signal comprises a pinion angle request; and
the measured steering signal is based on a measured pinion angle.
